(19) United States
(12) Patent Application Publication
(10) Pub. No.: US 2006/0116465 A1
(43) Pub. Date: Jun. 1, 2006

(54) Pneumatic tire

(75) Inventors: Misao Hiza, Hiratsuka-shi (JP); Kenichi Morita, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO., LTD.

(21) Appl. No.: 11/288,106

(22) Filed: Nov. 29, 2005

(30) Foreign Application Priority Data
Nov. 30, 2004 (JP) 2004-345995

(51) Int. Cl. C08K 3/34

(52) U.S. Cl. 524/493; 524/502

(57) ABSTRACT

A pneumatic tire using, as a tread, a rubber composition including (A) 30 to 90 parts by weight of a conjugated diene-based rubber composed of 40 to 95% by weight of 1,3-butadiene unit and 5 to 60% by weight of aromatic vinyl monomer units and having a Tg of −35° C. or more (B) natural rubber (BR), polybutadiene rubber (BR) and another styrene-butadiene copolymer rubber (SBR) different from the conjugated diene-based rubber (A) of 10 to 70 parts by weight of and (C) 10 to 110 parts by weight of, silica, or (A′) 30 to 90 parts by weight of a conjugated diene-based rubber composed of 30 to 94.9% by weight of 1,3-butadiene units 0.1 to 10% by weight of isoprene units and 5 to 60% by weight of aromatic vinyl monomer units (B′) 10 to 70 parts by weight of natural rubber (BR), polybutadiene rubber (BR) and another styrene-butadiene copolymer rubber (SBR) different from the rubber (A′) and (C) 10 to 110 parts by weight of silica wherein a groove area ratio of the tread is 25 to 34%, whereby a pneumatic tire realizing both dry and wet performance is provided.

### TECHNICAL FIELD

The present invention relates to a pneumatic tire, more specifically relates to a pneumatic tire achieving both dry performance and wet performance and having improved noise and abrasion resistance.

### BACKGROUND ART

It is known in the art that silica is compounded into a pneumatic tire. For example, Journal of the Adhesion Society of Japan, vol. 37, no. 5, p. 197 describes as to the latest technical issues in silica blending technology. On the other hand, the fact that copolymerizing isoprene with a diene-based rubber gives a rubber having a strong interaction with silica is for example described in Japanese Patent Publication (A) No. 2002-338741.

### DISCLOSURE OF INVENTION

The inventors recognized that, if the groove area ratio of a cap tread is made smaller, the dry performance, noise and abrasion resistance can be improved, but there is a problem that the wet performance deteriorates. On the other hand, a rubber composition composed of a known butadiene-aromatic vinyl copolymer rubber obtained by further copolymerization of isoprene units and containing silica is superior in wet performances such as wet braking ability, but the inventors deemed there is a problem of insufficient dry performances such as dry braking ability.

Accordingly, an object of the present invention is to provide a pneumatic tire achieving both dry performance and wet performance of the pneumatic tire and further having improved sound and abrasion resistance.

In accordance with the present invention, there is provided a pneumatic tire using, as a tread, a rubber composition comprising (A) 30 to 90 parts by weight of a conjugated diene-based rubber composed of 40 to 95% by weight of 1,3-butadiene unit and 5 to 60% by weight of aromatic vinyl monomer units and having a Tg of −35° C. or more, (B) 10 to 70 parts of, at least one conjugated diene-based rubber selected from the group consisting of natural rubber (NR), polybutadiene rubber (BR) and another styrene-butadiene copolymer rubber (SBR) different from the conjugated diene-based rubber (A) in an amount and (C) 10 to 110 parts of silica, a groove area ratio of the tread being 25 to 34%.

In accordance with the second aspect of the present invention, there is also provided a pneumatic tire using, as a tread, a rubber composition comprising (A′) 30 to 90 parts of a conjugated diene-based rubber composed of 30 to 94.9% by weight of 1,3-butadiene units 0.1 to 10% by weight of, isoprene units and 5 to 60% by weight of aromatic vinyl monomer units parts, (B′) 10 to 70 parts by weight of at least one conjugated diene-based rubber selected from the group consisting of natural rubber (NR), polybutadiene rubber (BR) and another styrene-butadiene copolymer rubber (SBR) different from the rubber (A′), and (C) silica 10 to 110 parts wherein a groove area ratio of the tread is 25 to 34%.

In accordance with the second aspect of the present invention, there is further provided a the above-mentioned pneumatic tire, wherein the conjugated diene-based rubber (A) is obtained by polymerizing a monomer mixture containing, in the monomers used for the polymerization, at least 80% by weight of the 1,3-butadiene, not more than 80% by weight of the isoprene, and at least 80% by weight of the aromatic vinyl monomer, then adding and polymerizing the remaining isoprene and further adding and polymerizing the remaining 1,3-butadiene and aromatic vinyl monomer, followed by reacting the polymer thus obtained with a coupling agent.

In accordance with the first and second aspects of the present invention, there is still further provided the above-mentioned pneumatic tire, wherein the tanδ/E′ of the rubber composition is 0.03 to 0.06.

### BEST MODE FOR WORKING THE INVENTION

It was difficult in the prior art to obtain a balance of dry performance and wet performance by just specifying the groove area ratio of the tire tread (the wet performance deteriorated), but, according to the present invention, by compounding silica into a blend of a specific ratio of a conjugated diene-based rubber of 1,3-butadiene/aromatic vinyl having a glass transition temperature Tg of −35° C. or more (A) and another conjugated diene-based rubber (B), or by compounding silica into a blend of a specific ratio between a conjugated diene-based rubber (A′) including isoprene units and an other conjugated diene-based rubber (B′), it is possible to provide a pneumatic tire improving the dry performance and wet performance with a good balance and also improving the noise and abrasion resistance. The use of SBR including isoprene units so as to improve the wet performance was not known at all in the past. Due to this, a pneumatic tire with a balance of high dry/wet performance can be obtained.

In summer tires of passenger cars, it is necessary to achieve a balance of a high dry/wet/rolling resistance performance. Therefore, the practice has been to improve the dry performance or sound and the abrasion resistance by reducing the groove area (25 to 34%), to obtain the wet performance by compounding silica into the rubber composition, and compounding a rubber polymer (A) having a Tg of −35° C. or more (specifically, a conjugated diene-based rubber composed of 40 to 95% by weight of a diene and 5 to 60% by weight of an aromatic vinyl monomer with natural rubber or another synthetic rubber to obtain a rubber composition having a tanδ/E′ of 0.03 to 0.06, preferably 0.04 to 0.055, for use for the cap tread or to make the groove area smaller (25-34%) and raise the friction of the rubber by compounding silica therein, strengthen the interaction between the silica and polymer by using an SBR containing isoprene together to draw out the performance of silica to a large extent to obtain a rubber composition with a good wet performance for use for the cap tread of a pneumatic tire so as to achieve the above object.

According to the present invention, the groove area ratio of the tire tread is made 25 to 34%, preferably 27 to 32%, which are smaller than the past. Here, the “groove area ratio” means the ratio of the area of the grooves to the tread surface as a whole. If this groove area ratio is too small, the water shedding ability is unpreferably decreased and the wet performance is unpreferably decreased. Conversely, if too large, the actual ground contact area becomes smaller and the dry performance and abrasion resistance are unpreferably decreased. Therefore, in the present invention, this problem is resolved by the following two means.

First, in the first aspect of the present invention, for the tire tread, in particular, the cap tread, a rubber composition comprising (A) 30 to 90 parts by weight of a conjugated diene-based rubber comprising 1,3-butadiene units in an amount of 40 to 95% by weight and aromatic vinyl monomer units in an amount of 5 to 60% by weight and having a glass transition temperature (Tg) of −35° C. or more, (B) 10 to 70 parts by weight of at least one conjugated diene-based rubber selected from the group of natural rubber (NR), polybutadiene rubber (BR), and another styrene-butadiene copolymer (SBR) different from the conjugated diene-based rubber (A) and (C) 10 to 110 parts by weight of silica is used.

In the rubber composition according to the present invention, the conjugated diene-based rubber compounded as the ingredient (A) is a copolymer containing 1,3-butadiene units in an amount of 40 to 95% by weight, preferably 55 to 90% by weight, and at least one aromatic vinyl units, for example styrene and methylstyrene, in an amount of 5 to 60% by weight, preferably 10 to 45% by weight. This conjugated diene-based rubber may be produced according an ordinary method using predetermined monomers and a catalyst by a solution polymerization method or emulsion polymerization method and, for example, is commercially available as Nipol Polymer (made by Nippon Zeon), etc.

In the rubber composition according to the present invention, the conjugated diene-based rubber compounded as the ingredient (B) is selected from other various types of SBR, natural rubber (NR), and various types of polybutadiene rubber (BR) different from said conjugated diene-based rubber and may include any rubber capable of compounding into rubber formulations, etc., and those commercially available may be used.

In the rubber composition according to the present invention, the components (A), (B) and (C) are blended in amounts of 30 to 90 parts by weight, preferably 40 to 80 parts by weight, 10 to 70 parts by weight, preferably 20 to 60 parts by weight and 10 to 110 parts by weight, preferably 50 to 90 parts by weight, respectively. Among these, the component (A) has the action of improving the dry performance and wet performance, the component (B) has the action of improving the abrasion resistance and the silica of the component (C) has the action of improving the wet performance. If the amount of the silica is too small, the effect of the silica cannot be obtained, and, therefore, this is not preferable. Conversely, if the amount of the silica is too large, the abrasion resistance is unpreferably decreased.

According to the second aspect of the present invention, the object is achieved by using for the tire tread, in particular the cap tread, a rubber composition comprising (A′) a conjugated diene-based rubber composed of 1,3-butadiene units in an amount of 30 to 94.9% by weight, isoprene units in an amount of 0.1 to 10% by weight and aromatic vinyl monomer units in an amount of 5 to 60% by weight in an amount of 30 to 90 parts by weight, (B′) at least one conjugated diene-based rubber selected from natural rubber (NR), polybutadiene rubber (BR) and other styrene-butadiene copolymers (SBR) different from rubber (A′) in an amount of 10 to 70 parts by weight and (C) silica in an amount of 10 to 110 parts by weight.

In the rubber composition according to the present invention, the conjugated diene-based rubber compounded as the ingredient (A′) is a copolymer comprising 1,3-butadiene units in an amount of 30 to 94.9% by weight, preferably 55 to 90% by weight, isoprene units in an amount of 0.1 to 10% by weight, preferably 0.15 to 7% by weight and at least one aromatic vinyl units, for example styrene and methylstyrene, in an amount of 5 to 60% by weight, preferably 10 to 45% by weight. Among these, if the amount of isoprene units is too small, the reinforcing property of the silica becomes unpreferably lower, while conversely if too large, the rubber becomes unpreferably too hard. This conjugated diene-based rubber can be produced according to an ordinary method using predetermined monomers and a catalyst by the solution polymerization method and is also commercially available as NS Polymer (made by Nippon Zeon) etc.

In the rubber composition according to the present invention, the conjugated diene-based rubber compounded as the ingredient (B′) is selected from other various types of SBR, natural rubber (NR), and various types of polybutadiene rubber (BR) different from the above conjugated diene-based rubber. It may be made any rubber capable of blending into rubber formulations, etc. Preferably, a commercially available one may be used.

In the rubber composition according to the present invention, the components (A′), (B′) and (C) are blended in amounts of 30 to 90 parts by weight, preferably 40 to 80 parts by weight, 10 to 70 parts by weight, preferably 20 to 60 parts by weight and 10 to 110 parts by weight, preferably 50 to 90 parts by weight, respectively. Among these, the component (A′) has the action of improving the dry and wet performance, the component (B′) has the action of improving the abrasion resistance, and the silica of the component (C) has the action of improving the wet performance.

The conjugated diene-based rubber (A′) is preferably obtained by polymerizing a monomer mixture containing, among the monomers used for the polymerization during its production, at least 80% by weight, preferably 50 to 90% by weight of the 1,3-butadiene, not more than 80% by weight, preferably 0.5 to 10% by weight of the isoprene and at least 80% by weight preferably 10 to 50% by weight of the aromatic vinyl monomer, then adding and polymerizing the remaining isoprene, further adding and polymerizing the remaining 1,3-butadiene and aromatic vinyl monomer, and thereafter reacting a coupling agent with the polymer. By polymerization by this method, there are the effects that blocks of isoprene units are produced and these blocks may react with the silica.

In the first and second aspects of the present invention, the silica compounded into the rubber composition as the component (C) may include any silica capable of being compounded for tire use or other rubber applications, for example wet silica, dry silica, etc. The properties thereof are not particularly limited, but preferably the nitrogen specific surface area N₂SA is 100 to 300 m²/g, determined by a method according to JIS K6217-2.

The rubber composition according to the present invention may contain, in addition to the above essential ingredients, carbon black or another filler, a vulcanization or cross-linking agent, a vulcanization or cross-linking accelerator, various types of oil, an antioxidant, a plasticizer, or other various types of additives for tire use or other general rubber use. These additives may be mixed by a general method to obtain a composition and used for vulcanization or cross-linking. The compounded amounts of these additives may be made conventional general compounded amounts insofar as the object of the present invention is not contravened.

### EXAMPLES

Examples will now be used to further explain the present invention, but the scope of the present invention is by no means limited to these Examples.

### Example 1 and Comparative Examples 1 to 4

Preparation of Samples

In each of the formulations of Table I, the ingredients other than the vulcanization accelerator and sulfur were mixed in a 3 liter internal mixer for 3 minutes and discharged, when reaching the temperature to 165±5° C. to obtain a master batch. This master batch was mixed with the vulcanization accelerator and sulfur by an open roll to obtain the unvulcanized rubber composition I, II or III.

Then, each of the rubber compositions I, II and III obtained above was vulcanized in a 15×15×0.2 cm mold at 160° C. for 20 minutes to prepare a vulcanized rubber sheet, which was then used for the measurement of the physical properties of the vulcanized rubber according to the following test methods. The results are shown in Table I. Further, each of the rubber compositions I, II and III obtained above was used for a tire tread to fabricate a size 185/60R15 pneumatic tire, of which tread groove area ratio is shown in Table II, which was then used for a driving test according to the following method to evaluate the braking ability and steering stability. The results are shown in Table II.

Test Methods for Evaluation of Physical Properties of Rubber

tanδ/E′

Measured using viscoelastic spectrometer (made by Toyo Seiki Seisakusho) at 0° C. and 60° C. at initial strain 10%, dynamic strain: ±2% and frequency 20 Hz.

Tire Usage Test

1) Wet braking ability: Car driven on wet paved road, braked at 100 km/h and ABS activated. Distance until stopping shown indexed to Comparative Example 7. The larger value, the shorter the stopping distance and the better the braking performance.

2) Wet steering stability: Car driven on wet paved road, steering wheel sharply turned by driver, and sense of response of tire etc. evaluated. Usually, the performance was evaluated with respect to a reference tire.
(Evaluation)
Good . . . superior steering stability
Fair . . . usual
Poor . . . inferior steering stability

3) Dry braking ability: Car driven on dry paved road, braked at 100 km/h, and ABS activated. Distance until stopping shown indexed to Comparative Example 7. The larger value, the shorter the stopping distance and the better the braking performance.

4) Dry steering stability: Car driven on wet paved road, steering wheel sharply turned by driver, and sense of response of tire etc. evaluated.

(Evaluation) same as in the wet stearing stability above

TABLE II
Pneumatic Tire Performance

| | | | Comp. | Comp. | Comp. | Comp. |
|---|---|---|---|---|---|---|
| | | Ex. 1 | Ex. 1 | Ex. 2 | Ex. 3 | Ex. 4 |
| Rubber composition | | I | I | I | II | III |
| used (see Table I) | | | | | | |
| Tread groove area | | 30% | 23% | 37% | 30% | 30% |
| ratio (%) | | | | | | |
| Wet per- | Braking | 106 | 95 | 112 | 100 | 90 |
| formance | ability | | | | | |
| | Steering | G | P | G | P | P |
| | stability | | | | | |
| Dry per- | Braking | 104 | 110 | 96 | 100 | 90 |
| formance | ability | | | | | |
| | Steering | G | G | P | G | P |
| | stability | | | | | |

TABLE I
Composition of Tread Rubber

| | | I | II | III |
|---|---|---|---|---|
| Formulation | | | | |
| (parts by weight) | | | | |
| Polymer: | HP752*¹ | 97 | 97 | — |
| | SBR 1712*² | — | — | 97 |
| | Nipol 1220*³ | 12 | 12 | 12 |
| | Natural rubber*⁴ | 17 | 17 | 17 |
| Filler: | Z165GR*⁵ | 59 | 0 | 20 |
| | Seast 9M*⁶ | 19 | 78 | 58 |
| ZnO*⁷ | | 2 | 2 | 2 |
| Stearic acid*⁸ | | 1 | 1 | 1 |
| Processing aid | EF44*⁹ | 2.5 | 2.5 | 2.5 |
| Oil*¹⁰ | | 15.34 | 15.34 | 15.34 |
| Antioxidant | S-13*¹¹ | 3.15 | 3.15 | 3.15 |
| | RD*¹² | 2 | 2 | 2 |
| Wax | OZOACE*¹³ | 1.65 | 1.65 | 1.65 |
| Sulfur*¹⁴ | | 1.85 | 1.85 | 1.85 |
| CBS*¹⁵ | | 2.3 | 2.3 | 2.3 |
| DPG*¹⁶ | | 0.5 | 0.5 | 0.5 |
| Evaluated physical | | | | |
| properties | | | | |
| tanδ/E′ | | 0.048 | 0.045 | 0.026 |

Footnote of Table I
*¹SBR (styrene content 37.8% by weight, vinyl content 41%, Tg = −27° C.) made by JSR
*²SBR1712 (styrene content 23.5%, ML₁₊₄ = 49, oil extended 37.5 phr) made by Nippon Zeon
*³BR (BR1220) made by Nippon Zeon
*⁴Natural rubber TSR
*⁵Silica (N₂SA = 165 m²/g) made by Rhodia
*⁶Carbon black (N₂SA = 141 m²/g) made by Tokai Carbon
*⁷Zinc Oxide No. 3 made by Seido Chemical
*⁸Industrial use stearic acid made by NOF Corporation
*⁹EF-44 made by Structol
*¹⁰Aromatic oil made by Showa Shell Oil
*¹¹Antioxidant Santoflex 6PPD made by Flexsys
*¹²Antioxidant Flectol TMQ made by Flexsys
*¹³Paraffin wax made by Nippon Seiro
*¹⁴5% oil-containing sulfur powder made by Tsurumi Chemical
*¹⁵Vulcanization accelerator (N-cyclohexyl-2-benzothiazolyl sulfenamide) made by Flexsys
*¹⁶Vulcanization accelerator (diphenylene guanidine) made by Flexsys

### Example 2 and Comparative Example 5 to 7

Preparation of Samples

In each of the formulations of Table III, the ingredients other than the vulcanization accelerator and sulfur were mixed by a 3 liter internal mixer for 3 minutes and discharged when reaching the temperature to 165±5° C. to obtain a master batch. The master batch thus obtained was mixed with the vulcanization accelerator and sulfur by an open roll to obtain the unvulcanized rubber compositions IV and V.

Next, each of the rubber compositions IV and V obtained above was vulcanized in a 15×15×0.2 cm mold at 160° C. for 20 minutes to prepare a vulcanized rubber sheet which was measured for the physical properties of the vulcanized rubber by the test methods shown above. The results are shown in Table III. Further, each of the rubber compositions IV and V obtained above was used for the tire tread to fabricate a size 185/60R15 pneumatic tire (the rubber composition used and tire tread groove area ratio shown in Table IV), which was evaluated for tire performance by the above methods. The results are shown in Table IV.

TABLE III
Tread Rubber Composition

| | | IV | V |
|---|---|---|---|
| Formulation | | | |
| (parts by weight) | | | |
| Polymer: | Polymer*¹ | 97 | — |
| | Polymer*² | — | 97 |
| | Nipol 1220*³ | 12 | 12 |
| | Natural rubber*⁴ | 17 | 17 |
| Filler: | Z165GR*⁵ | 59 | 20 |
| | Seast 9M*⁶ | 19 | 58 |
| ZnO*⁷ | | 2 | 2 |
| Stearic acid*⁸ | | 1 | 1 |
| Working aid | EF44*⁹ | 2.5 | 2.5 |
| oil*¹⁰ | | 15.34 | 15.34 |
| Antioxidant | S-13*¹¹ | 3.15 | 3.15 |
| | RD*¹² | 2 | 2 |
| Wax | OZOACE*¹³ | 1.65 | 1.65 |
| Sulfur*¹⁴ | | 1.85 | 1.85 |
| CBS*¹⁵ | | 2.3 | 2.3 |
| DPG*¹⁶ | | 0.5 | 0.5 |
| Evaluated physical | | | |
| properties | | | |
| tanδ/E′ | | 0.052 | 0.048 |

Footnotes of Table III
*¹SBR made by Nippon Zeon (styrene content 20% by weight, vinyl content 60% by weight, isoprene content 0.9% by weight, Tg = −29° C., weight average molecular weight 490,000, oil extended 37.5 phr)
*²SBR made by Nippon Zeon (styrene content 23% by weight, vinyl content 71% by weight, Tg = −27° C., weight average molecular weight 1,170,000, oil extended 37.5 phr)
*³ to *¹⁶See notes to Table I

TABLE IV
Pneumatic Tire Performance

| | | | Compar- | Compar- | Compar- |
|---|---|---|---|---|---|
| | | Example | ative | ative | ative |
| | | 2 | Example 5 | Example 6 | Example 7 |
| Rubber composition | | IV | IV | IV | V |
| used (see Table III) | | | | | |
| Tread groove area | | 30% | 23% | 37% | 30% |
| ratio (%) | | | | | |
| Wet per- | Braking | 104 | 97 | 105 | 100 |
| formance | ability | | | | |
| | Steering | Good | Poor | Good | Poor |
| | stability | | | | |
| Dry per- | Braking | 102 | 100 | 96 | 100 |
| formance | ability | | | | |
| | Steering | G | G | P | G |
| | stability | | | | |

### INDUSTRIAL APPLICABILITY

According to the present invention, regardless of reducing the groove area ratio of the tire tread, by using silica and a high Tg SBR or by using silica and isoprene-containing SBR, it is possible to increase the tanδ/E′ ratio of the compound, to improve the wet performance without having a detrimental effect on the dry performance, to improve the sound, and to improve the abrasion resistance, so the invention is useful as a pneumatic tire.

1. A pneumatic tire using, as a tread, a rubber composition comprising (A) 30 to 90 parts by weight of a conjugated diene-based rubber composed of 40 to 95% by weight of 1,3-butadiene unit and 5 to 60% by weight of aromatic vinyl monomer units and having a Tg of −35° C. or more, (B) 10 to 70 parts of, at least one conjugated diene-based rubber selected from the group consisting of natural rubber (NR), polybutadiene rubber (BR) and another styrene-butadiene copolymer rubber (SBR) different from the conjugated diene-based rubber (A) in an amount and (C) 10 to 110 parts of silica, a groove area ratio of the tread being 25 to 34%.

2. A pneumatic tire using, as a tread, a rubber composition comprising (A′) 30 to 90 parts of a conjugated diene-based rubber composed of 30 to 94.9% by weight of 1,3-butadiene units 0.1 to 10% by weight of, isoprene units and 5 to 60% by weight of aromatic vinyl monomer units parts, (B′) 10 to 70 parts by weight of at least one conjugated diene-based rubber selected from the group consisting of natural rubber (NR), polybutadiene rubber (BR) and another styrene-butadiene copolymer rubber (SBR) different from the rubber (A′), and (C) silica 10 to 110 parts wherein a groove area ratio of the tread is 25 to 34%.

3. A pneumatic tire as claimed in claim 2, wherein the conjugated diene-based rubber (A) is obtained by polymerizing a monomer mixture containing, in the monomers used for the polymerization, at least 80% by weight of the 1,3-butadiene, not more than 80% by weight of the isoprene, and at least 80% by weight of the aromatic vinyl monomer, then adding and polymerizing the remaining isoprene and further adding and polymerizing the remaining 1,3-butadiene and aromatic vinyl monomer, followed by reacting the polymer thus obtained with a coupling agent.

4. A pneumatic tire as claimed in claim 1, wherein the tanδ/E′ of the rubber composition is 0.03 to 0.06.

5. A pneumatic tire as claimed in claim 2, wherein the tanδ/E′ of the rubber composition is 0.03 to 0.06.
